(19) United States
(12) Patent Application Publication
(10) Pub. No.: US 2008/0057374 A1
(43) Pub. Date: Mar. 6, 2008

(54) HYDROGEN SUPPLY PIPE CONNECTING STRUCTURE

(75) Inventor: Atsushi Kurosawa, Shizuoka-ken (JP)

Correspondence Address: KNOBBE MARTENS OLSON & BEAR LLP, 2040 MAIN STREET, FOURTEENTH FLOOR, IRVINE, CA, 92614, US

(73) Assignee: YAMAHA HATSUDOKI KABUSHIKI KAISHA, Shizuoka-ken (JP)

(21) Appl. No.: 11/836,597

(22) Filed: Aug. 9, 2007

(30) Foreign Application Priority Data
Aug. 29, 2006 (JP) 2006-231574
Oct. 16, 2006 (JP) 2006-280952

(51) Int. Cl. H01M 8/04

(52) U.S. Cl. 429/34

(57) ABSTRACT

A hydrogen supply pipe connecting structure facilitates attachment/detachment of a hydrogen supply pipe used to connect a fuel cell and a hydrogen tank where an electronic component is mounted nearby. The hydrogen supply pipe for a fuel cell system, which is used to generate electric power by reacting hydrogen gas with oxygen gas, comprises a first and second gas pipe with a male coupler on the first gas pipe and a female coupler on the second gas pipe. A solenoid valve is disposed on a hydrogen tank to connect the solenoid valve to the male coupler through an electric wire and to connect a power source system control device to the female coupler through an electric wire. The solenoid valve and the power source system control device are electrically connected to each other or disconnected from each other in accordance with attachment/detachment of the female coupler and the male coupler. In addition, the solenoid valve and the power source system control device are connected to each other after the female coupler and the male coupler are connected in an airtight manner.

### CROSS-REFERENCE TO RELATED APPLICATIONS

This application claims the priority benefit of Japanese Patent Application No. 2006-231574, which was filed on Aug. 29, 2006 and Japanese Patent Application No. 2006-280952, which was filed on Oct. 16, 2006, each of which is hereby incorporated by reference in its entirety.

### BACKGROUND OF THE INVENTION

1. Field of the Invention

The present invention relates to a hydrogen supply pipe connecting structure, which is provided in a system having a fuel cell for generating electric power by reacting hydrogen gas with oxygen gas.

2. Description of the Related Art

Conventionally, there have been systems, vehicles, and the like, which have a fuel cell for generating electric power by reacting hydrogen gas with oxygen gas in order to generate electric power for operation of the vehicle. In some of these fuel cell systems, two hydrogen supply pipes, which are respectively joined to a fuel cell and a hydrogen tank for storing hydrogen gas, are connected to each other with a detachable connecting section (see JP-A-Hei 10-064567, for example).

The connecting section of the system comprises a valve body and a metal bush fitting. The valve body has a threaded component provided on an inner circumferential surface on its connection port side. Within the valve body, a valve element is disposed such that it is urged by a spring onto a valve seat on the connection port side to close a flow path. A threaded portion that is engageable with the valve body threaded portion is provided on an outer circumference of a distal end of the metal bush fitting. Two threaded portions are engaged to connect the valve body and the metal bush fitting so that the distal end of the metal bush fitting moves the valve element rearward to place the valve body in communication with the metal bush fitting.

### SUMMARY OF THE INVENTION

However, in the conventional fuel cell system, a hydrogen tank needs to be replaceable for when the remaining amount of hydrogen gas decreases. In addition, in case the fuel cell system has an electronic component, such as solenoid opening-closing valve, mounted on a part of the hydrogen supply pipe on the hydrogen tank side, replacement of a high-pressure hydrogen tank involves attachment/detachment of the connecting section as well as attachment/detachment of an electric wire for connecting between the electronic component and a controller for controlling operation of the electronic component. This disadvantageously makes replacement of the hydrogen tank cumbersome.

Thus, an object of an embodiment that is arranged and configured in accordance with certain features, aspects and advantages of the present invention is to provide a hydrogen supply pipe connecting structure to facilitate attachment/detachment of a hydrogen supply pipe for connecting a fuel cell and a hydrogen tank that has an electronic component mounted nearby.

In one embodiment, a hydrogen supply pipe connecting structure is used for a system having a fuel cell used to generate electric power by reacting hydrogen gas, which hydrogen gas is supplied from a hydrogen tank through a hydrogen supply pipe, and oxygen gas, which oxygen gas is supplied from an air supply device through an air supply pipe, in which the hydrogen supply pipe comprises a hydrogen tank side pipe and a fuel cell side pipe. A hydrogen tank side coupler is provided on a distal end portion of the hydrogen tank side pipe and a fuel cell side coupler, which is detachably connected to the hydrogen tank side coupler, is provided on a distal end portion of the fuel cell side pipe. An electronic component is disposed on the hydrogen tank side pipe or the hydrogen tank to connect the electronic component to the hydrogen tank side coupler through an electronic component side electric wire and to connect a control device for controlling the electronic component to the fuel cell side coupler through a control device side electric wire. The electronic component and the control device are electrically connected to each other or disconnected from each other in accordance with attachment/detachment of the hydrogen tank side coupler and the fuel cell side coupler.

### BRIEF DESCRIPTION OF THE DRAWINGS

These and other features, aspects and advantages of embodiments of the present invention will be described below with reference to the attached drawings. The drawings comprise the following figures.

FIG. 1 is a side view illustrating a motorcycle having a first embodiment of a hydrogen supply pipe connecting structure arranged and configured in accordance with certain features, aspects and advantages of the invention.

FIG. 2 is a schematic diagram of an example of a fuel cell system.

FIG. 3 is a sectional view illustrating a connecting structure with a female coupler and a male coupler disconnected from each other.

FIG. 4 is a sectional view illustrating the connecting structure with the female coupler and the male coupler connected to each other.

FIG. 5 is a sectional view illustrating the connecting structure with the female coupler and the male coupler connected to each other and electrical contact being made.

FIG. 6 is a sectional view illustrating another connecting structure with a female coupler and a male coupler disconnected from each other.

FIG. 7 is a sectional view illustrating the female coupler and the male coupler connected to each other.

FIG. 8 is a sectional view illustrating the female coupler and the male coupler connected to each other and electrical contact being made.

FIG. 9 is a front view of the female coupler shown in FIG. 6.

FIG. 10 is a front view of the male coupler shown in FIG. 6.

FIG. 11 is a sectional view a further connecting structure with a female coupler and a male coupler disconnected from each other.

FIG. 12 is a sectional view illustrating the female coupler and the male coupler connected to each other.

FIG. 13 is a sectional view illustrating the female coupler and the male coupler connected to each other.

FIG. 14 is another connecting structure with a female coupler and a male coupler disconnected from each other.

FIG. 15 is a sectional view illustrating the female coupler and the male coupler approaching each other.

FIG. 16 is a sectional view illustrating the female coupler and the male coupler after they have been brought together.

FIG. 17 is a sectional view illustrating the female coupler and the male coupler connected to each other.

### DETAILED DESCRIPTION OF THE PREFERRED EMBODIMENT

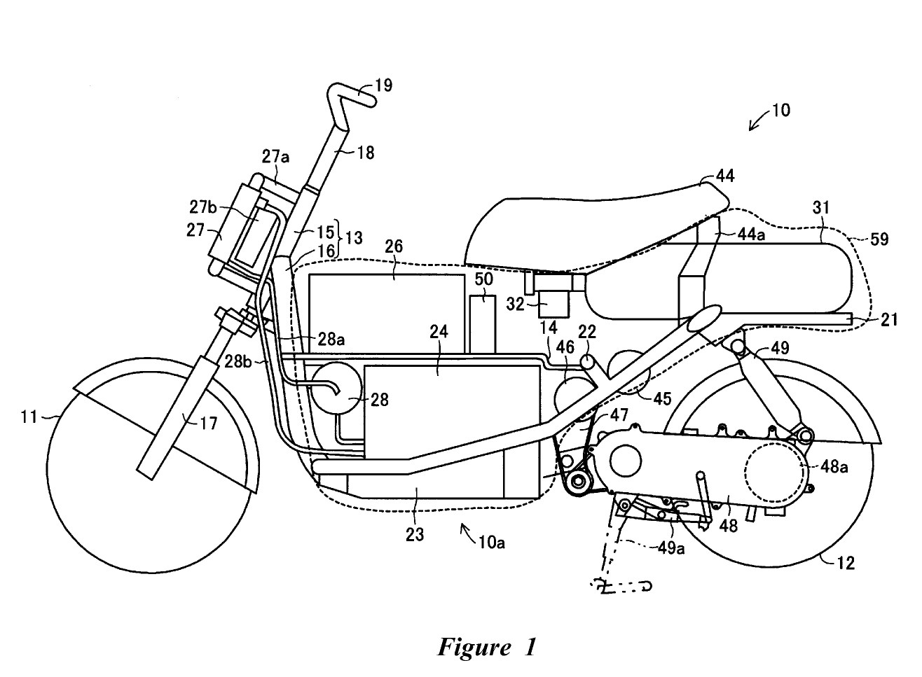

Detailed description is hereinafter made with reference to the drawings of a hydrogen supply pipe connecting structure according to a first embodiment that is arranged and configured in accordance with certain features, aspects and advantages of the invention. FIG. 1 shows a motorcycle 10 having the hydrogen supply pipe connecting structure. The motorcycle 10 has at least a pair of wheels, including a front wheel 11 and a rear wheel 12, and a vehicle body 10a, to which the paired wheels are attached. The vehicle body 10a comprises a body frame 13, which forms a basic portion of the vehicle body 10a, and a sub-frame 14 that preferably is removably attached to the body frame 13. The body frame 13 comprises a head pipe 15, which defines a front part of the vehicle body 10a, and a main frame 16 that extends rearward from the head pipe 15.

The front wheel 11 is rotatably supported at the lower end of a front fork 17, which comprises a two-forked lower portion. More specifically, a bearing (not shown) extends across the lower end portions of the front fork 17 to support an axle of the front wheel 11. This allows the front wheel 11 to rotate about the axle through the bearing. The lower end of a steering shaft 18, which can be placed in a head pipe 15, is connected to the upper end of the front fork 17. The steering shaft 18 is attached to the head pipe 15 for rotation about the axis of the head pipe 15 and has an upper end protruding from the head pipe 15 and extending upward.

The upper end of the steering shaft 18 is connected to the center of a pair of handlebars 19, which are disposed generally horizontally. Therefore, when the pair of handlebars 19 are rotated to rotate the steering shaft 18 about its axis, the front wheel 11 turns to the right or left about the axis of the front fork 17 in proportion to the amount of steering shaft rotation. Grips (not shown) preferably are provided at both ends of the pair of handlebars 19.

One of the grips preferably rotates about its axis and defines an accelerator operation element, which controls the drive power of a drive motor 48a in addition to being used as a grip portion which is held by a hand. The other grip is fixed to the handlebar 19 and used as a grip portion which is held by a hand. Brake levers (not shown), which are urged away from the grips and cause the rotation of the front wheel 11 or the rear wheel 12 to slow down when pulled toward the grips, are disposed in the vicinity of the grips.

The main frame 16 comprises a pair of curved frames (only one of which is shown), the front ends (upper ends) of which are connected to the sides of a lower portion of the head pipe 15. The main frames 16 extend backward and obliquely downward from the joints with the head pipe 15 with the distance between them increasing. The main frames 16 then are curved and extend horizontally backward. In addition, the main frames 16 have rear end portions extending backward and obliquely upward with the distance between them kept generally constant. The rear ends of the main frames 16 are connected to a generally horizontal plate-shaped mounting member 21.

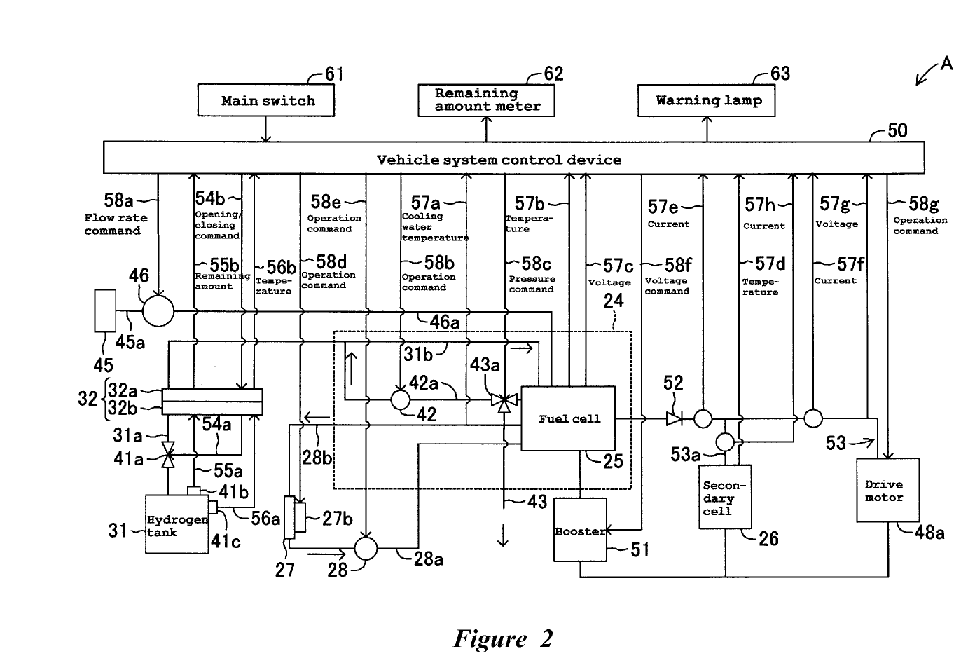

A cross member 22 extends across upper sides of rear portions of the main frames 16. The cross member 22 is formed in a generally U-shaped rod with both ends bent generally at a right angle. A main portion of the cross member 22 preferably protrudes upward from the main frames 16 with the bent ends connected to the main frames 16. A mount table 23 protrudes downward between the main frames 16 and extends across the lower ends of the main frames 16. The upper side of the mount table 23 is recessed to form therein an accommodating section 24. A fuel cell 25 (see FIG. 2) is positioned in the accommodating section 24.

A plate-like sub-frame 14 is attached between a front part of the main frames 16 and the cross member 22 is disposed on rear parts of the main frames 16. A lithium ion battery, which can define a secondary battery 26, is fixed to a part of the upper surface of the sub-frame 14 at a location slightly forward of the center thereof and a power source system control device 50 for controlling the devices, which a fuel cell system A shown in FIG. 2 has, is fixed on a rear portion of the upper surface of the sub-frame 14.

A radiator 27 can be attached to a front part of the head pipe 15 with a fixing member 27a and a fan 27b for air-cooling the radiator 27 can be attached behind the radiator 27 (i.e., between the radiator 27 and the head pipe 15). A water pump 28 is attached to a front part of the main frame 16 in front of the accommodating section 24 and below the sub-frame 14 (i.e., at a location below the secondary battery 26). A cooling water pipe 28a connects the radiator 27 and the fuel cell 25. The water pump 28 can provided along the cooling water pipe 28a.

The cooling water pipe 28a preferably extends from the radiator 27 to the water pump 28 and then from the water pump 28 to the accommodating section 24. The cooling water pipe 28a also extends into the accommodating section 24 through a front side thereof and is connected to the fuel cell 25. A cooling water pipe 28b connects between the fuel cell 25 and the radiator 27. Cooling water, which has cooled the fuel cell 25, flow through the cooling water pipe 28b from the fuel cell 25 toward the radiator 27. Therefore, when the water pump 28 is activated, the cooling water in the radiator 27 is fed to the fuel cell 25 through the cooling water pipe 28a to cool the fuel cell 25. Then, the cooling water that has cooled the fuel cell 25 and absorbed heat therefrom is returned to the radiator 27 through the cooling water pipe 28b and cooled by the fan 27b while passing through the radiator 27.

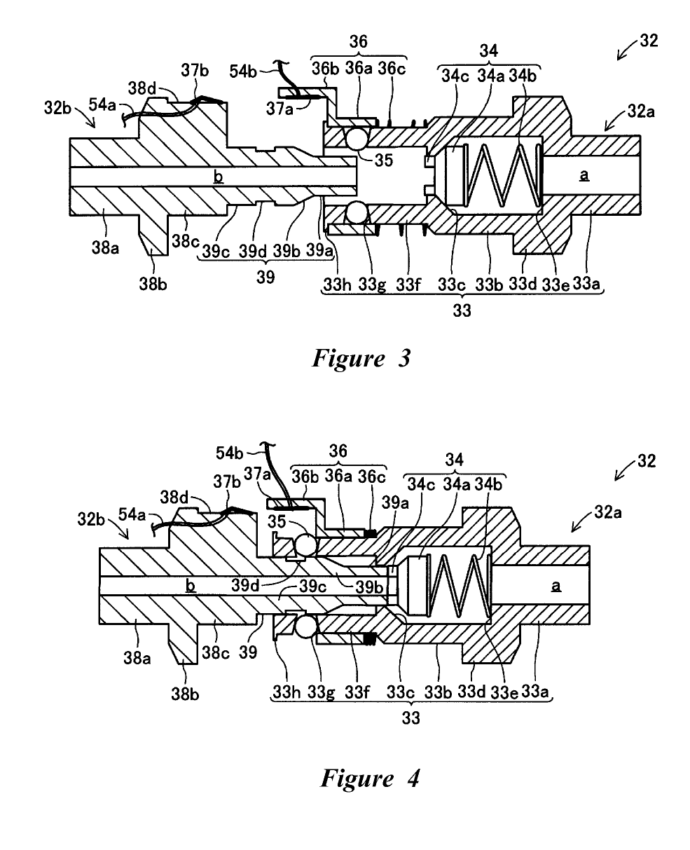

A hydrogen tank 31, which is filled with hydrogen to be supplied to the fuel cell 25, is attached to the upper side of the mounting member 21, which is connected to the rear ends of the main frame 16. As shown in FIG. 2, the hydrogen tank 31 is connected to a hydrogen gas supply port of the fuel cell 25 through a gas pipe 31a, which can define a hydrogen tank side pipe, a detachable coupler 32, and a gas pipe 31b, which can define a fuel cell side pipe. As shown in FIGS. 3 to 5, the detachable coupler 32 preferably comprises a female coupler 32a, which defines a fuel cell side coupler, and a male coupler 32b, which defines a hydrogen tank side coupler, that is detachable from the female coupler 32a.

The female coupler 32a comprises a main body 33 with its interior formed as a hydrogen supply path (a), a valve member 34 contained in the main body 33, as well as a spherical engaging member 35 and an attachment/detachment operation section 36, both of which are used for attaching/detaching the female coupler 32a to/from the male coupler 32b. The main body 33 is generally shaped into a stepped cylinder, including axially extending portions of predetermined different diameters. A proximal end portion of the main body 33 (i.e., the right part in FIG. 3) comprises a joint part 33a of a relatively small diameter, which is joined to an end portion of the gas pipe 31b. A center portion of the main body 33 in the axial direction comprises an accommodating part 33b of a relatively large diameter. A tapered valve seat 33c is formed on an inner circumferential surface of the accommodating part 33b at a distal end portion thereof with the valve seat 33c having an inner diameter that is smaller toward the distal side. A flange-shaped gripping part 33d is formed on an outer circumference at a border area between the joint part 33a and the accommodating part 33b. A stepped part 33e is formed on an inner circumferential surface of the gripping part 33d.

The distal end portion of the main body 33 comprises an engaging part 33f that engages with the male coupler 32b. The engaging part 33f preferably is formed into a cylinder including portions having a diameter slightly smaller than the diameter of the accommodating part 33b and having a diameter slightly larger than the diameter of the joint part 33a. At the distal side portion of the engaging part 33f, plural holes 33g preferably are circumferentially provided at generally equal intervals. Each hole 33g extends through from the inner surface to the outer surface of the engaging part 33f. Each hole 33g (internal space) preferably is formed into a truncated conical shape with its inner diameter on the outer surface of the engaging part 33f being larger than its inner diameter on the inner surface thereof. The spherical engaging member 35 is placed in each hole 33g.

The valve member 34 is placed within the accommodating part 33b. The valve member 34 comprises a valve element 34a and a coil spring 34b, which can define a resilient elastic member. The valve element 34a is shaped into a thick disk with its front end portion tapered to be contactable to the valve seat 33c in the accommodating part 33b in a generally airtight manner. The coil spring 34b can be fixed to the rear end plane of the valve element 34a. Plural projections 34c can be formed circumferentially at generally equal intervals on a front plane of the valve body 34, the front plane having a relatively small diameter. An outer diameter defined by all the projections 34c preferably is slightly smaller than an inner diameter of an aperture of the valve seat 33c, such that the projections 34c are inserted through the aperture of the valve seat 33c.

The valve member 34 thus configured allows the stepped part 33e inside the accommodating part 33b to support the rear end portion of the coil spring 34b. The valve member 34 is placed within the accommodating part 33b with the valve element 34a urged toward the valve seat 33c by the coil spring 34b. Therefore, as shown in FIG. 3, when the female coupler 32a and the male coupler 32b are not connected to each other, the front plane of the valve element 34a is pressed toward and fitted to the valve seat 33c with the projections 34c inserted through the aperture of the valve seat 33c. Thereby, the hydrogen supply path (a) of the female coupler 32a is kept closed.

The generally spherical engaging member 35 is movably positioned within the hole 33g. A diameter of the spherical engaging member 35 is slightly larger than a thickness of the engaging part 33f (i.e., the axial length of the hole 33g). When the spherical engaging member 35 is located on the outermost side of the hole 33g, one end portion of the spherical engaging member 35 protrudes from the inner side of the engaging part 33f, and the other end portion of the spherical engaging member 35 is located in position to correspond with the outer circumferential surface of the engaging part 33f. The attachment/detachment operation section 36 is fitted to the outer circumferential surface of the engaging part 33f. The attachment/detachment operation section 36 comprises a generally cylindrical detachable part 36a, an operation lever 36b provided at the distal end portion of the detachable part 36a, which can define a protruding piece, and a coil spring 36c.

The detachable part 36a is movable along the outer circumferential surface of the engaging part 33f. When the detachable part 36a is located on the distal side of the engaging part 33f, the detachable part 36a abuts on the spherical engaging member 35 and the detachable part 36a moves the spherical engaging member 35 toward the innermost side of the hole 33g. The spherical engaging member 35 is then secured by the inner circumferential surfaces of the hole 33g and the detachable part 36a. When the detachable part 36a is located on the proximal side of the engaging part 33f, that is, the detachable part 36a is located closer to the proximal side of the engaging part 33f than the spherical engaging member 35, then the spherical engaging member 35 is movable within the hole 33g.

When the detachable part 36a is located on the proximal side of the engaging part 33f, if the spherical engaging member 35 protrudes outward from the hole 33g, the inner circumferential distal end portion of the detachable part 36a preferably abuts on the rearward (proximal side) part of the protruding spherical engaging member 35 to reduce the likelihood that the spherical engaging member 35 will fully escape the hole 33g. The end portion of the spherical engaging member 35 on the inner side of the engaging part 33f is located in position to correspond with the inner circumferential surface of the engaging part 33f. The coil spring 36c is placed on the outer circumferential surface of the engaging part 33f to urge the detachable part 36a forward, with its front end portion in contact with a rear end plane of the detachable part 36a and its rear end portion positioned at the step formed on the boarder area between the accommodating part 33b and the engaging part 33f.

A flange-shaped stopper 33h is formed at an edge of the engaging part 33f on its outer circumferential surface to retain the detachable part 36a. The stopper 33h reduces the likelihood of the detachable part 36a separating from the engaging part 33f. The operation lever 36b comprises piece having an L-shape in cross-section, which piece extends radially from the edge of the detachable part 36a, and then extends forward such that it is generally coaxial to the detachable part 36a.

A terminal 37a, which can define a control device side terminal, preferably is fixed to an inner surface of the forward extending portion of the operation lever 36b. The terminal 37a preferably is formed into a rectangular shape with its longitudinal side longer relative to its lateral side. The terminal 37a is mounted along the inner surface of the operation lever 36b with its front end and rear end fixed to the operation lever 36b. Although FIGS. 3 to 5 only show a one piece of terminal 37a, the terminal 37a preferably comprises four pieces that are arranged side by side, such as around the circumference of the lever 36b.

The male coupler 32b is generally shaped into a stepped cylinder, including axially extending portions of predetermined different diameters. The interior of the male coupler 32b is formed into a hydrogen supply path (b). A proximal end portion of the male coupler 32b (i.e., the left part in FIG. 3) comprises a joint part 38a of a large diameter (e.g., approximately as large as the diameter of the joint part 33a of the female coupler 32a), which is joined to an end portion of the gas pipe 31a. A distal end portion of the male coupler 32b comprises a communicating section 39, which can define a pressing section. The communicating section 39 preferably is engaged with the engaging part 33f of the female coupler 32a, such that, when the communicating section 39 and the engaging part 33f are secured together, the hydrogen supply path (a) of the female coupler 32a is connected with the hydrogen supply path (b) of the male coupler 32b. For the sake of convenience for explanation, the right side of the female coupler 32a, shown in FIGS. 3 to 5, is referred to as the proximal side or the rearward side while the left side of the female coupler 32a is referred to as the distal side or the forward side. In contrast, the left side of the male coupler 32b, shown in FIGS. 3 to 5, is referred to as the proximal side or the rearward side while the right side of the male coupler 32b is referred to as the distal side or the forward side.

The communicating section 39 comprises a small-diameter distal end part 39a, which can be inserted into the accommodating part 33b in sliding contact with a peripheral edge of the aperture of the valve seat 33c, a tapered part 39b whose outer diameter increases from the rear end portion of the small-diameter distal end part 39a to the rearward side, and a large-diameter rear end part 39c, which is formed on the rearward side of the tapered part 39b and can be inserted into the engaging part 33f in sliding contact with the inner circumferential surface thereof. At an approximately axial center of the large-diameter rear end part 39c, a circumferential shallow engaging groove 39d is formed.

The engaging groove 39d is formed in position to face the hole 33g of the engaging part 33f when the female coupler 32a and the male coupler 32b are connected to each other in a generally airtight manner. The engaging groove 39d preferably has dimensions to accommodate, together with the hole 33g, the spherical engaging member 35. In other words, the sum of the depth of the hole 33g (i.e., the thickness of the engaging part 33f) and the depth of the engaging groove 39d approximately equal, or are slightly larger than, the diameter of the spherical engaging member 35. In addition, a flange-shaped gripping part 38b is formed on the forward side of the joint part 38a of the male coupler 32b. A main body 38c, which is approximately as thick as the joint part 38a, is formed between the gripping part 38b and the joint section 39.

A projection 38d can be formed on a portion of the main body 38c, which corresponds to the operation lever 36b of the attachment/detachment operation section 36. When the female coupler 32a and the male coupler 32b are connected to each other, the projection 38d is in the vicinity of, and opposed to, the inner surface of the operation lever 36b. A terminal 37b, which can define an electronic component side terminal, is fixed to the outer surface of the projection 38d. The terminal 37b can be formed into a generally rectangular shape with its longitudinal side longer relative to its lateral side. The terminal 37b is mounted with its front end and rear end fixed to the projection 38d and comprises a bent center portion that protrudes outward. The terminal 37b comprises four pieces, which are arranged side by side at intervals generally corresponding to those of the four terminals 37a.

The gas pipes 31a and 31b are detachably connected with the detachable coupler 32 thus configured. The gas pipe 31a is provided with an opening-closing solenoid valve 41a. The hydrogen tank 31 is provided with a hydrogen remaining amount detecting sensor 41b and a temperature sensor 41c. An electronic component can be defined by one or more of the solenoid valve 41a, the hydrogen remaining amount detecting sensor 41b, and the temperature sensor 41c.

A hydrogen gas discharge port of the fuel cell 25 is connected to the gas pipe 31b through a gas pipe 42a. A circulation pump 42 for returning unreacted hydrogen gas, discharged from the hydrogen gas discharge port of the fuel cell 25 to the gas pipe 31b is provided in the gas pipe 42a.

A gas purge pipe 43 for discharging gas out of the gas pipe 42a is connected to a portion of the gas pipe 42a on the fuel cell 25 side through a three-way valve 43a. Therefore, while the female coupler 32a and the male coupler 32b are connected to each other, opening the solenoid valve 41a allows hydrogen gas in the hydrogen tank 31 to be supplied to the fuel cell 25 through the gas pipes 31a, 31b.

When the circulation pump 42 is activated in the connecting state, unreacted hydrogen gas remaining in the fuel cell 25 can be returned to the gas pipe 31b through the gas pipe 42a and joined to hydrogen gas newly fed from the hydrogen tank 31 into the gas pipe 31b. Then, the hydrogen gas is circulated in the gas pipes 31b, 42a before being reacted with oxygen gas in the fuel cell 25. In addition, when the gas and the remaining water in the gas pipe 42a and the fuel cell 25 are discharged, the three-way valve 43a is switched to communicate the upstream side portion of the gas pipe 42a with the gas purge pipe 43.

A seat 44 is disposed above a front part of the hydrogen tank 31. The seat 44 is connected to rear parts of the main frames 16a via support members 44a. An air filter 45 is mounted at the rear of the cross member 22 on the rear parts of the main frames 16. An air blower 46, which can define an air supply device, is mounted in front of the cross member 22 on the rear parts of the main flames 16. A mount table (not shown) is provided between rear parts of the main frames 16, and the air filter 45 and the air blower 46 are fixed to the main frames 16 via the mount table.

The gas pipes 45a, 46a, which can define an air supply pipe, respectively connect the air filter 45 and the air blower 46 to each other and the air blower 46 and the fuel cell 25 to each other. Thus, when the air blower 46 is activated, outside air is sucked through the air filter 45 and delivered to the fuel cell 25. Dust in the air sucked into the air filter 45 is removed while the air passes through the air filter 45. When passing through the fuel cell 25, the air, excluding oxygen gas that has reacted with hydrogen gas to generate electric power by the fuel cell 25, is discharged externally.

A rear arm (not shown) having a pair of arm members extending backward is connected to lower rear parts of the main frames 16 via a connection member 47. Both ends of the axle of the rear wheel 12 are rotatably supported at the rear ends of the arm members of the rear arm to allow rotation of the rear wheel 12 about the axle. A motor unit 48 is attached to the outside of one of the arm members of the rear arm in such a manner as to cover the arm member.

A drive motor 48a, which is operated on electric power generated by the fuel cell 25, and a reduction mechanism are housed in the motor unit 48. The rear wheel 12 is rotated by the operation of the drive motor 48a such that the motorcycle 10 operates. Rear cushions 49 extend between the rear ends of the main frames 16 and the upper rear ends of the rear arm. The expansion and contraction of the rear cushions 49 allows swinging movement of the rear end of the rear arm. A drum brake (not shown) is attached on the side of the inner side the motor unit 48.

The drive motor 48a is operated by control of the power source system control device 50 in accordance with the amount by which the grip is operated and automatically generates drive power in the rear wheel 12. The motorcycle 10 has a rotary stand 49a for keeping the motorcycle 10 in an upright state when it is in a stationary state. The stand 49a is moved to its upper position as shown by solid lines in FIG. 1 when the motorcycle 10 is operated and the stand 49a moved to its lower position, as shown by double-dot dash lines in FIG. 1, so that the stand 49a can support the motorcycle 10 when the motorcycle 10 is held stationary or parked.

In addition, the fuel cell system A has a booster 51 for raising the voltage of the electric power generated by the fuel cell 25 and a backflow-preventing diode 52. An electric circuit 53 comprises the fuel cell 25, the secondary battery 26, the drive motor 48a, the booster 51, the diode 52, and electric wires that connect these components, for instance. The devices that form the fuel cell system A preferably are provided with respective sensors (not shown) for detecting various conditions of the devices, in addition to the hydrogen remaining amount detecting sensor 41b that detects the remaining amount of hydrogen in the hydrogen tank 31 and the temperature sensor 41c that detects the temperature of the hydrogen tank 31. These sensors and the respective devices, such as the solenoid valve 41a, preferably are connected to the power source system control device 50 through electric wires.

To be more specific, the solenoid valve 41a is connected to the terminal 37b of the male coupler 32b through an electric wire 54a, which can define an electrical component side wire. The terminal 37a of the male coupler 32a and the power source system control device 50 are connected through the electric wire 54b, which can define a control device side wire. Thus, connecting the female coupler 32a and the male coupler 32b to each other allows the solenoid valve 41a to be electrically connected to the power source system control device 50 and, therefore, allows the solenoid valve 41a to be operable under the control of the power source system control device 50.

Similarly, the hydrogen remaining amount detecting sensor 41b is electrically connectable to the power source system control device 50 through an electric wire 55a that connects the hydrogen remaining amount detecting sensor 41b and the terminal 37b provided on the male coupler 32b and through an electric wire 55b that connects the terminal 37a provided on the female coupler 32a and the power source system control device 50. Also, the temperature sensor 41c is electrically connectable to the power source system control device 50 through an electric wire 56a that connects the temperature sensor 41c and the terminal 37b provided on the male coupler 32b and through an electric wire 56b that connects the terminal 37a provided on the female coupler 32a and the power source system control device 50. The hydrogen remaining amount detecting sensor 41b and the temperature sensor 41c transmit electrical signals of their respective detected values to the power source system control device 50.

The cooling water pipe 28b is provided with a temperature sensor that detects the temperature of the cooling water, which is fed from the radiator 27 to the fuel cell 25 to cool the fuel cell 25 and then fed from the fuel cell 25 back to the radiator 27. The fuel cell 25 is provided with a temperature sensor that detects the temperature of the fuel cell 25 and a voltage sensor that detects the voltage value in the fuel cell 25. The secondary battery 26 is provided with a temperature sensor that detects the temperature of the secondary battery 26.

The electric circuit 53 is provided with a current sensor that detects a value of the current flowing through the electric circuit 53. The electric circuit 53 also is provided with a current sensor and a voltage sensor that detect values of the current and the voltage flowing through the drive motor 48a, respectively. Further, an electric wire 53a connected to the secondary battery 26 in the electric circuit 53 is provided with a current sensor that detects the value of current flowing to the secondary battery 26. These sensors are connected to the power source system control device 50 through respective electric wires 57a, 57b, 57c, 57d, 57e, 57f, 57g, 57h to transmit electric signals of the detected values to the power source system control device 50.

Electric wires 58a, 58b, 58c, 58d, 58e, 58f, 58g, which transmit a command signal from the power source system control device 50 to the air blower 46, the circulation pump 42, the three-way valve 43a, the fan 27b, the water pump 28, the booster 51 and the drive motor 48a respectively, connect the power source system control device 50 and the corresponding devices. The air blower 46 is activated in response to a flow rate command signal from the power source system control device 50 to supply air to the fuel cell 25. The solenoid valve 41a is opened or closed in response to an opening/closing command signal from the power source system control device 50 to supply hydrogen gas from the hydrogen tank 31 to the fuel cell 25.

The fuel cell 25 generates water and electricity through a reaction between oxygen in the air supplied from the air blower 46 and hydrogen supplied from the hydrogen tank 31. At that time, the circulation pump 42 is activated in response to an operation command signal from the power source system control device 50 and returns hydrogen gas, which has not reacted with oxygen gas in the fuel cell 25, to the gas pipe 31b through the gas pipe 42a to join it to hydrogen gas newly fed from the hydrogen tank 31 into the gas pipe 31b. The three-way valve 43a communicates the upstream side of the gas pipe 42a with the downstream side thereof or with the gas purge pipe 43 in response to a switching command signal from the power source system control device 50.

The water pump 28 is activated in response to an operation command signal from the power source system control device 50 and circulates cooling water between the radiator 27 and the fuel cell 25 to maintain the temperature of the fuel cell 25 at a prescribed temperature. The fan 27b is activated in response to an operation command signal from the power source system control device 50 to air-cool the radiator 27. The booster 51 raises the voltage of the electricity generated by the fuel cell 25 in response to a voltage command signal from the power source system control device 50 and the booster 51 supplies the electricity to the drive motor 48a and to the secondary battery 26 to charge the secondary battery 26. The drive motor 48a receives an operation signal corresponding to the amount by which the grip, which defines an accelerator operation element, is operated. The operation signal can be sent from the power source system control device 50. The drive motor 48a can be activated in response to the operation signal.

The power source system control device 50 has a CPU, a RAM, a ROM, a timer, and so on. Various programs and data, such as a map that can be prepared in advance, are stored in the ROM. The CPU controls the drive motor 48a, the solenoid valve 41a, the three-way valve 43a, the air blower 46, the water pump 28, and so on based on the driver's operation of the grip or based on the programs prepared in advance. In addition, the motorcycle 10 has a main switch 61, a remaining amount meter 62 that displays a detected value of the hydrogen remaining amount detecting sensor 41b, and a warning lamp 63 that issues an alert in the event of an abnormal condition occurring in any of the respective devices provided in the fuel cell system A. An external surface of the vehicle body 10a of the motorcycle 10 can be covered with a cover member 59 so that the internal devices are not visible.

In this configuration, when mounting a hydrogen tank 31 filled with hydrogen gas on the motorcycle 10, a part of the cover member 59 that covers the hydrogen tank 31, can be opened to place the hydrogen tank 31 on the mounting member 21. Then, the hydrogen tank 31 can be fixed to the mounting member 21 with a fixing member and then the female coupler 32a and the male coupler 32b can be connected to each other. When being connected, the female coupler 32a and the male coupler 32b can be positioned to face each other, as shown in FIG. 3 and, after that, the female coupler 32a and the male coupler 32b can be brought together in order to insert the communicating section 39 of the male coupler 32b into the engaging part 33f of the female coupler 32a.

When the tapered part 39b of the communicating section 39 abuts on the spherical engaging member 35, the operation lever 36b of the female coupler 32a is moved rearward against the resilience of the coil spring 36c so that the detachable part 36a is located closer to the proximal end of the female coupler 32a than the spherical engaging member 35. This enables the spherical engaging member 35 to move within the hole 33g so that the female coupler 32a and the male coupler 32b further approach each other. Accordingly, the spherical engaging member 35 passes over the tapered part 39b and is located on the outer circumferential surface of the large-diameter rear end part 39c. At this point, as shown in FIG. 4, the small-diameter distal end part 39a of the communicating section 39 presses and moves the valve element 34a rearward against the resilience of the coil spring 34b.

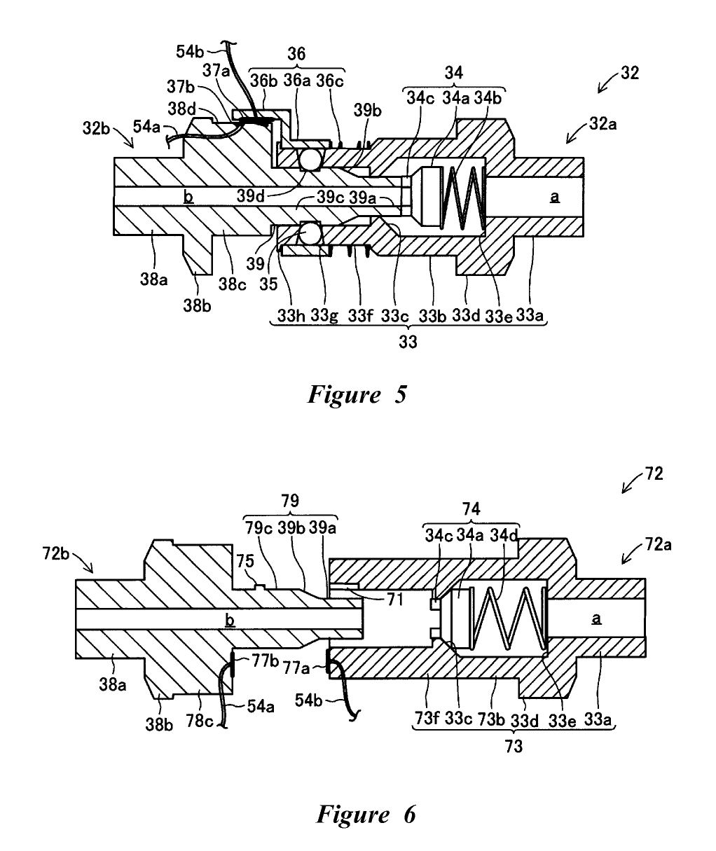

Accordingly, the outer circumferential surface of the small-diameter distal end part 39a contacts the peripheral edge of the aperture of the valve seat 33c in a generally airtight manner and the hydrogen supply path (a) of the female coupler 32a and the hydrogen supply path (b) of the male coupler 32b are placed in communication with each other through gaps between the plural projections 34c provided on the front plane of the valve element 34a. Then, the female coupler 32a and the male coupler 32b further approach each other. When the hole 33g and the engaging groove 39d overlap one another, a force holding the operation lever 36b back is released. Thereby, the detachable part 36a is pressed back to the front by the resilience of the coil spring 36c, as shown in FIG. 5. In this condition, the spherical engaging member 35 is secured by the hole 33g, the detachable part 36a, and the engaging groove 39d, maintaining the connection between the female coupler 32a and the male coupler 32b through the spherical engaging member 35.

In addition, the small-diameter distal end part 39a and the valve seat 33c are kept generally airtight, while the female coupler 32a and the male coupler 32b are held in communication with each other. Further, when the force pressing the operation lever 36b is released, causing the detachable part 36a to move forward, the terminals 37a, 37b overlap with their surfaces in frictional contact such that the terminals 37a, 37b are brought into electrical connection. Thereby, the electric wires 54a, 54b connect to each other to enable the solenoid valve 41a to activate. Respectively connecting the electric wires 55a, 55b to each other and connecting the electric wires 56a, 56b to each other allows the hydrogen remaining amount detecting sensor 41b and the temperature sensor 41c to both start activation. Once the connection has been accomplished, the cover member 59 is closed.

Next, the main switch 61 is turned on to drive the motorcycle 10. Then, air and hydrogen are supplied to the fuel cell 25 from air blower 46 and the hydrogen tank 31, respectively, and the fuel cell 25 generates electricity through a reaction between oxygen in the supplied air and the hydrogen. While the motorcycle 10 is being operated, moving the grip allows the motorcycle 10 to run at a given speed and moving the handlebars 19 allows the motorcycle 10 to be directed in a given direction.

When the hydrogen tank 31 is replaced, for example, when little or no hydrogen gas remains in the hydrogen tank 31, the aforementioned process for connecting the female coupler 32a and the male coupler 32b is performed in the reverse order. More specifically, while the operation lever 36b is moved rearward from the position shown in FIG. 5 in order to enable the spherical engaging member 35 to move, the terminals 37a and 37b are disconnected from each other. Then, the female coupler 32a and the male coupler 32b are moved away from each other. After the small-diameter distal end part 39a of the communicating section 39 is removed from the valve seat 33c, the valve element 34a is pressed on the valve seat 33c due to the resiliency of the coil spring 34b, closing the hydrogen supply path of the female coupler 32a. Upon this condition, the driver releases the hand from the operation lever 36b.

As described above, in one configuration of the hydrogen supply pipe connecting structure, when the female coupler 32a and the male coupler 32b are connected to each other to place the gas pipes 31a, 31b into communication with each other, the electric wires 54a, 54b also are connected, which allows the solenoid valve 41a to activate. At the same time, connecting the electric wires 55a, 55b to each other and connecting the electric wires 56a, 56b to each other allows the hydrogen remaining amount detecting sensor 41b and the temperature sensor 41c respectively to both start operating. This eliminates the necessity of an operation for connecting the electric wire 54a and so forth, facilitating the connecting operations. In addition, the electric wires 54a, 54b are connected to each other after the female coupler 32a and the male coupler 32b are connected to each other in a generally airtight manner. Therefore, unless the female coupler 32a and the male coupler 32b are connected to each other in an airtight manner, the solenoid valve 41a cannot operate so that no hydrogen gas is discharged from the hydrogen tank 31.

In order to connect the female coupler 32a and the male coupler 32b, the terminals 37a, 37b overlap with their surfaces in frictional contact with each other such that they are brought into electrical connection. Thus, in the event dust adheres to, or an oxide film is formed on, the surfaces of the terminals 37a, 37b, for example, frictionally contacting the surfaces of the terminals 37a and 37b with each other results in removal of the dust or the oxide film. Thereby, the contact between the terminal 37a and the terminal 37b can be maintained in good condition.

In addition, when the female coupler 32a and the male coupler 32b are connected to each other, the remaining amount meter 62 displays their connection. Therefore, the display allows the driver to confirm that the female coupler 32a and the male coupler 32b have been suitably connected. In the aforementioned embodiment, the detachable coupler 32 is provided with four sets of terminals, including the four terminals 37a and the four terminals 37b. Three of these sets of terminals are used for connecting the solenoid valve 41a, the hydrogen remaining amount detecting sensor 41b, and the temperature sensor 41c respectively to the power source system control device 50. The other terminal pair is used as a grounding terminal.

FIGS. 6 to 8 show a hydrogen supply pipe connecting structure according to a second embodiment that is arranged and configured in accordance with certain features, aspects and advantages of the present invention. In the hydrogen supply pipe connecting structure, a detachable coupler 72 comprises a female coupler 72a and a male coupler 72b, as shown in FIGS. 6 to 8. The female coupler 72a comprises a main body 73 and a valve member 74 generally contained in the main body 73. The main body 73 comprises an accommodating part 73b and an engaging part 73f formed at its center portion and distal end portion in the axial direction, respectively. The accommodating part 73b and the engaging part 73f preferably have a generally cylindrical shape with a substantially equal outer diameter.

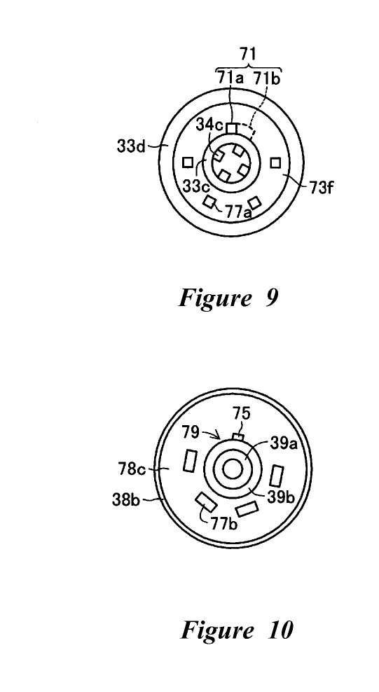

In the illustrated configuration, no through hole is formed on a circumferential surface of the engaging part 73f, but an engaging groove 71 can be provided on an inner surface of the engaging part 73f at its distal side portion. As shown in FIG. 9, the engaging groove 71 comprises a guide part 71a that extends rearward from the distal end of the engaging part 73f in the axial direction. The engaging groove 71 also comprises an engaging part 71b that bends from the rearmost end of the guide part 71a and extends generally circumferentially. Thus, the guide part 71a and the engaging part 71b form a generally L-shaped configuration. Four terminals 77a, which define a control device side terminal, are fixed to a front end plane of the engaging part 73f at given intervals.

In the illustrated configuration, no engaging groove is provided but an engaging projection 75 can be provided on a large-diameter rear end part 79c of the communicating section 79 of the male coupler 72b. The engaging projection 75 can be engaged with the engaging groove 71 of the female coupler 72a. In other words, the engaging projection 75 is inserted into the guide part 71a of the engaging groove 71 and, when the engaging projection 75 reaches the rearmost end of the guide part 71a, the female coupler 72a and the male coupler 72b are rotated relative to each other about their axis. This allows the engaging projection 75 to be engaged with the engaging part 71b, thereby maintaining the connection between the female coupler 72a and the male coupler 72b. The main body 78c of the male coupler 72b can be formed into an approximately cylindrical shape having a relatively large outer diameter.

As shown in FIG. 10, four terminals 77b, which can define an electronic component side terminal, are fixed to a plane of the main body 78c that faces the four terminals 77a of the female coupler 72a (i.e., the plane defines an opposed section) at intervals corresponding to those for the terminals 77a. The terminals 77b are mounted in position such that they are electrically connected to the terminals 77a when the engaging projection 75 is engaged with the engaging part 71b of the engaging groove 71. In the illustrated hydrogen supply pipe connecting structure, components other than those mentioned above can be the same as the components in the hydrogen supply pipe connecting structure described above with reference to the first embodiment. It is thus understood that similar components are identified by the same reference numerals and description of those components may not be repeated.

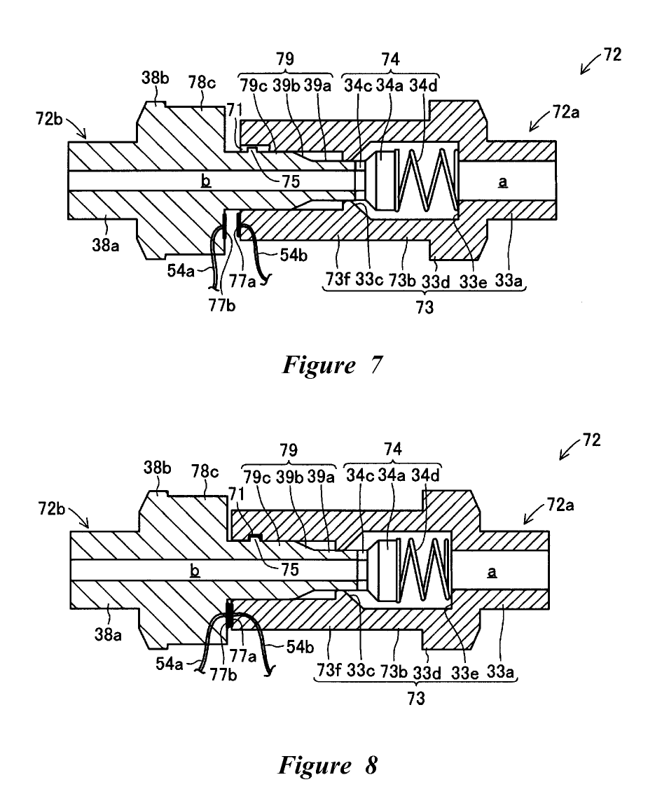

In order to connect the female coupler 72a and the male coupler 72b, the female coupler 72a and the male coupler 72b, which face each other as shown in FIG. 6, are brought together and then the communicating section 79 of the male coupler 72b is inserted into the engaging part 73f of the female coupler 72a, as shown in FIG. 7. One the female coupler 72a and the male coupler 72b have initially been brought together, the female coupler 72a and the male coupler 72b are brought further together with the engaging projection 75 inserted into the guide part 71a of the engaging groove 71. When the engaging projection 75 reaches the rearmost end of the guide part 71a, the female coupler 72a and the male coupler 72b can be rotated relative to each other about their axes. Thus, the engaging projection 75 is engaged with the engaging part 71b of the engaging groove 71, which maintains the connection between the female coupler 72a and the male coupler 72b as shown in FIG. 8.

When the engaging projection 75 is engaged with the engaging part 71b, the outer circumferential surface of the small-diameter distal end part 39a contacts the peripheral edge of the aperture of the valve seat 33c in a generally airtight manner and the hydrogen supply path (a) of the female coupler 72a and the hydrogen supply path (b) of the male coupler 72b are brought into communication with each other through the gaps defined between the plural projections 34c provided on the front plane of the valve element 34a. When the female coupler 72a and the male coupler 72b are rotated relative to each other about their axes, the terminals 77a, 77b are electrically connected with frictional contact between their surfaces. The functions and effects of the hydrogen supply pipe connecting structure, other than those mentioned above, are generally the same as in the first embodiment of the hydrogen supply pipe connecting structure.

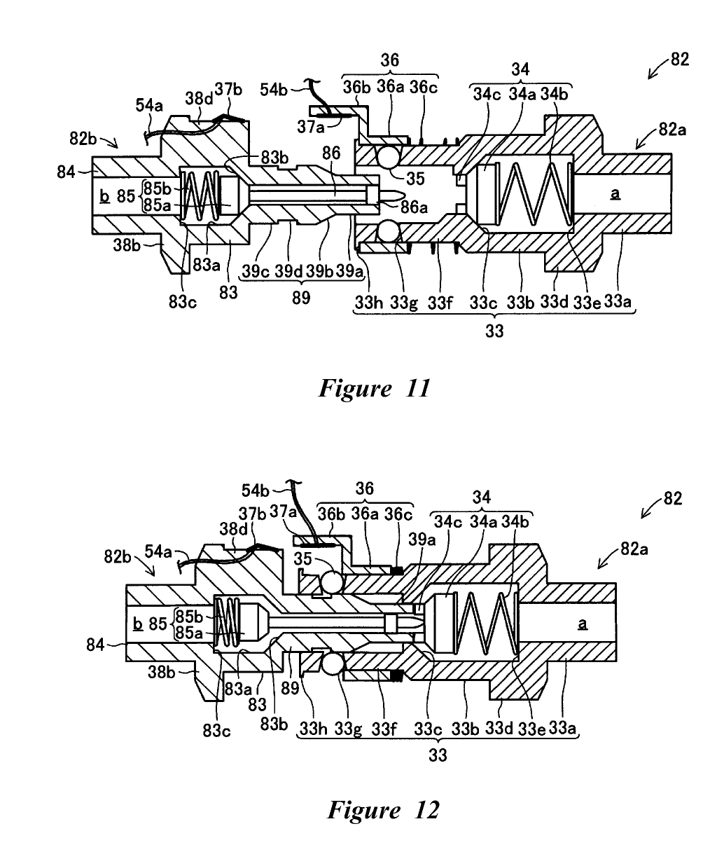

FIGS. 11 to 13 show a further hydrogen supply pipe connecting structure embodiment that is arranged and configured in accordance with certain features, aspects and advantages of the present invention. In the illustrated hydrogen supply pipe connecting structure, a detachable coupler 82 comprises a female coupler 82a and a male coupler 82b, as shown in FIGS. 11 to 13. A main body 83, which can be located on the center portion of the male coupler 82b, is formed into an approximately cylindrical shape and has an interior as an accommodating part 83a that forms a large-diameter hydrogen supply path. A tapered valve seat 83b is formed on an inner circumferential surface of the accommodating part 83a at its distal side portion such that an inner diameter of the tapered valve seat 83b decreases toward the distal side. A stepped part 83c is formed on the inner circumferential surface of the accommodating part 83a at its proximal side portion such that an inner diameter of the stepped part 83c is smaller on its proximal end than on its distal end. An inner circumferential diameter of the joint section 84 that forms the proximal end portion of the male coupler 82b is generally the same as the inner circumferential diameter of the accommodating part 83a on its smaller-diameter side.

A valve member 85 is placed in the accommodating part 83a. The valve member 85 comprises a valve element 85a and a coil spring 85b, which can define a resilient member. The valve element 85a is shaped into a thick disk with its front end portion tapered such that it can contact the valve seat 83c in the accommodating part 83b in a generally airtight manner. The coil spring 85b is fixed to the rear end plane of the valve element 85a. The valve member 85 thus configured allows the stepped part 83c inside the accommodating part 83a to support the rear end portion of the coil spring 85b. The valve member 85 is placed within the accommodating part 83a with the valve element 85a urged toward the valve seat 83b by the resilience of the coil spring 85b.

A pressing rod 86 extends forward from the front plane of the valve body 85a, generally at its center portion. The front plane has a relatively small diameter when compared to the balance of the valve body 85a. The pressing rod 86 preferably comprises a rod-shaped member that can be inserted through the interior of the communicating section 89 provided on the distal end side of the male coupler 82b. The pressing rod 86 preferably is longer than the axial length of the communicating section 89. A flange-shaped guide part 86a can be provided circumferentially at the distal side portion of the pressing rod 86, such that the guide part 86a slidably contacts the inner circumferential surface of the communicating section 89. The guide part 86a is provided such that it is positioned at the distal end portion of the communicating section 89 (shown in FIG. 11) when the valve element 85a contacts the valve seat 83b.

In the illustrated hydrogen supply pipe connecting structure, the communicating section 89 and the pressing rod 86 generally define a pressing section. In the illustrated hydrogen supply pipe connecting structure, components other than those mentioned above preferably are generally the same as the components described above in the first embodiment of the hydrogen supply pipe connecting structure. It is thus understood that similar components will use the same reference numerals and description of those components may not be repeated. A resilient force of the coil spring 85b preferably is slightly smaller than the resilient force of the coil spring 34b.

In the illustrated structure, to connect the female coupler 82a and the male coupler 82b, the female coupler 82a and the male coupler 82b, which face each other as shown in FIG. 11, are brought toward each other and then the communicating section 89 of the male coupler 82b is inserted into the engaging part 33f of the female coupler 82a, as shown in FIG. 12. Then, the operation lever 36b of the female coupler 82a is moved rearward to position the detachable part 36a closer to the proximal side of the female coupler 82a than the spherical engaging member 35. Under this condition, the tapered part 39b of the communicating section 89 contacts the spherical engaging member 35.

With the tapered part 39b of the communicating section 89 contacting the spherical engaging member 35, the female coupler 82a and the male coupler 82b are brought further together, which moves the spherical engaging member 35 beyond the tapered part 39b onto the outer circumferential surface of the large-diameter rear end part 39c. Thereby, the distal end portion of the pressing rod 86 abuts on the distal plane of the valve element 34a. The coil spring 85b is compressed and the distal end portion of the pressing rod 86 is moved rearward within the communicating section 89. When the female coupler 82a and the male coupler 82b are brought yet further together, the small-diameter distal end part 39a of the communicating section 89 abuts on the projections 34c and presses the valve element 34a against the resiliency of the coil spring 34b to displace it rearward, as shown in FIG. 12.

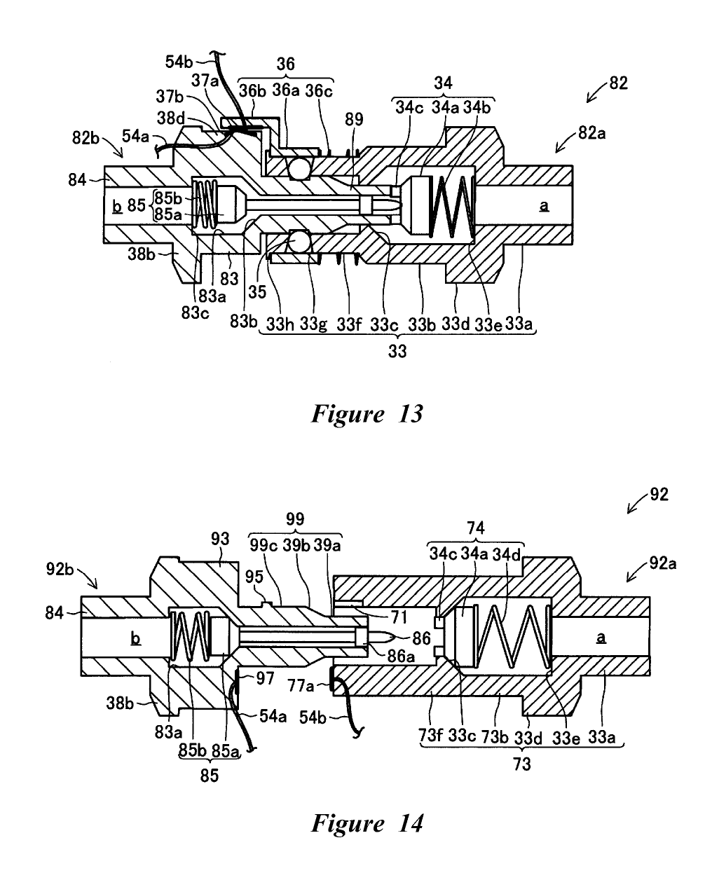

The female coupler 82a and the male coupler 82b then can be brought still further together. When the hole 33g and the engaging groove 39d overlap one another, a force pressing the operation lever 36b is released. Thereby, the detachable part 36a is pressed back to the front by the resilience of the coil spring 36c, as shown in FIG. 13. In this condition, the spherical engaging member 35 is secured by the hole 33g, the detachable part 36a, and the engaging groove 39d, which maintains the connection between the female coupler 82a and the male coupler 82b through the spherical engaging member 35.

In such case, the outer circumferential surface of the small-diameter distal end part 39a contacts the peripheral edge of the aperture of the valve seat 33c in a generally airtight manner and the hydrogen supply path (a) of the female coupler 82a and the hydrogen supply path (b) of the male coupler 82b communicate with each other through the gaps between the plural projections 34c provided on the front plane of the valve element 34a. Further, when the force pressing the operation lever 36b is released, the detachable part 36a moves forward and the terminals 37a and 37b overlap with their surfaces in frictional contact with each other such that they are brought into electrical connection. Thus, the electric wires 54a, 54b connect to each other to enable operation of the solenoid valve 41a. The functions and effects of the hydrogen supply pipe connecting structure, other than those mentioned above, are generally the same as in the hydrogen supply pipe connecting structures described above, such as with respect to the first embodiment.

FIGS. 14 to 17 show yet another hydrogen supply pipe connecting structure that is arranged and configured in accordance with an embodiment of the present invention. In the illustrated hydrogen supply pipe connecting structure, a detachable coupler 92 comprises a female coupler 92a and a male coupler 92b, such as shown in FIGS. 14 to 17. The female coupler 92a preferably is generally the same in structure as the female coupler 72a described above in the second embodiment. Therefore, components of the female coupler 92a identical to those of the female coupler 72a shown in FIGS. 6 to 8 will be denoted by the same reference numerals and description of those components may not be repeated.

In the illustrated configuration, no engaging groove is provided but an engaging projection 95 is provided on a large-diameter rear end part 99c of a communicating section 99 of the male coupler 92b. The engaging projection 95 is engageable with the engaging groove 71 of the female coupler 92a. A main body 93 of the male coupler 92b can be formed into an approximately cylindrical shape having a large outer diameter. Four terminals 97 can be fixed to a plane of the main body 93 with the plane facing the four terminals 77a of the female coupler 92a at intervals generally corresponding to those for the terminals 77a of the female coupler. Components of the male coupler 92b, other than those mentioned above, generally are the same as the components of the male coupler 82b described above with reference to the third embodiment. Therefore, components of the male coupler 92b that correspond to those of the male coupler 82b shown in FIGS. 11 to 13 will be denoted by the same reference numerals and description of those components may not be repeated.

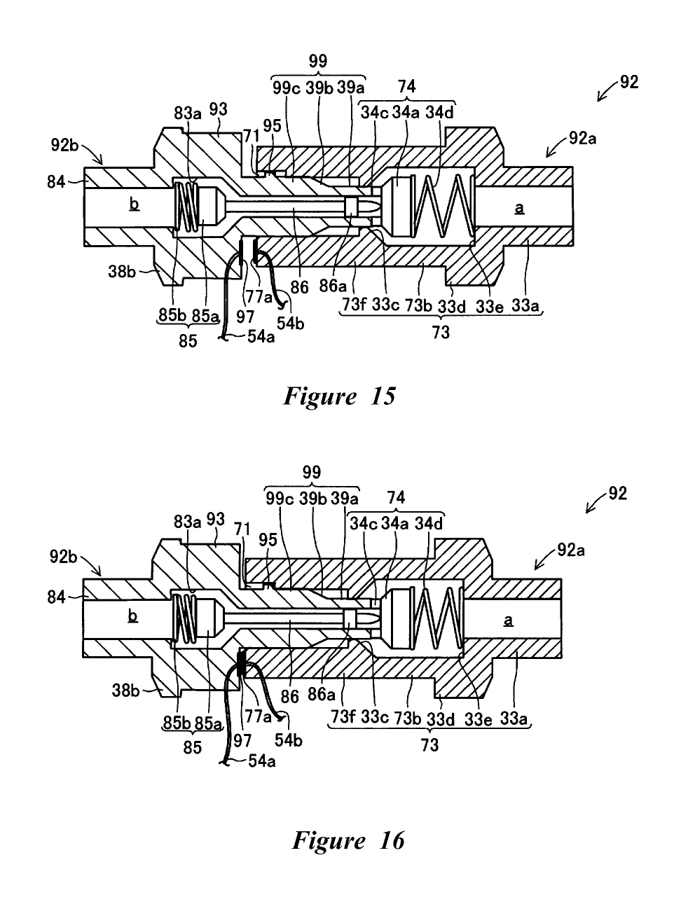

In the illustrated structure, to connect the female coupler 92a and the male coupler 92b, the female coupler 92a and the male coupler 92b, which face each other as shown in FIG. 14, are moved toward each other and then the communicating section 99 of the male coupler 92b is inserted into the engaging part 73f of the female coupler 92a, as shown in FIG. 15. When the female coupler 92a and the male coupler 92b are brought further together with the engaging projection 95 inserted into the guide part 71a of the engaging groove 71, the distal end portion of the pressing rod 86 abuts on the valve element 34a such that the coil spring 85b is compressed. Compression of the coil spring 85b allows the distal end portion of the pressing rod 86 to move rearward within the communicating section 99.

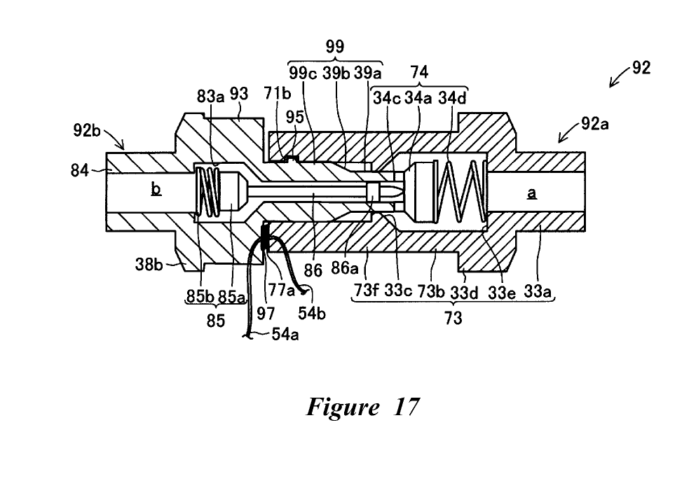

When the female coupler 92a and the male coupler 92b are brought yet further together, the small-diameter distal end part 39a of the communicating section 99 abuts on the projections 34c and presses the valve element 34a against the resiliency of the coil spring 34b such that it moves rearward, as shown in FIG. 15. When the female coupler 92a and the male coupler 92b continue to move together, and the engaging projection 95 reaches the rearmost end of the guide part 71a as shown in FIG. 16, the female coupler 92a and the male coupler 92b are rotated relative to each other in the axial direction. Thereby, the engaging projection 95 is engaged with the engaging part 71b of the engaging groove 71, which maintains the connection between the female coupler 92a and the male coupler 92b, as shown in FIG. 17.

Thus, the outer circumferential surface of the small-diameter distal end part 39a contacts the peripheral edge of the aperture of the valve seat 33c in a generally airtight manner and the hydrogen supply path (a) of the female coupler 92a and the hydrogen supply path (b) of the male coupler 92b are brought into communication with each other through the gaps defined between the plural projections 34c provided on the front plane of the valve element 34a. When the female coupler 92a and the male coupler 92b are rotated relative to each other in the axial direction, the terminals 77a, 97 are electrically connected with a frictional contact between their surfaces. The functions and effects of the hydrogen supply pipe connecting structure, other than those mentioned above, preferably are generally the same as in the hydrogen supply pipe connecting structures described above.

The hydrogen supply pipe connecting structure need not be limited to the embodiments described above and may be modified as needed or desired. For example, in the aforementioned embodiments, the solenoid valve 41a, the hydrogen remaining amount detecting sensor 41b, and the temperature sensor 41c are provided as an electronic component. In some embodiments, any one or two of them may form an electromagnetic or electronic component. Also, in the aforementioned embodiments, the female coupler 32a and so forth are connected to the gas pipe 31b while the male coupler 32b and so forth are connected to the gas pipe 31a. In some embodiments, the female coupler 32a and so forth may be connected to the gas pipe 31a, while the male coupler 32b and so forth may be connected to the gas pipe 31b.

Further, in the aforementioned third and fourth embodiments, the pressing rod 86 is provided at the center portion of the front plane of the valve element 85a. In some embodiments, the pressing rod 86 may be provided at the center portion of the front plane of the valve element 34a. In addition, although the hydrogen supply pipe connecting structure is applied to the motorcycle in the embodiments described above, the system which uses the hydrogen supply pipe connecting structure is not limited to the illustrated motorcycle and may be another vehicle, such as a three-wheeled motor vehicle or four-wheeled motor vehicle, for example, or may be a system that uses electric power other than vehicles. The components of the hydrogen supply pipe connecting structure may be modified as needed or desired within the technical scope of the present application.

Although the present invention has been described in terms of certain embodiments, other embodiments apparent to those of ordinary skill in the art also are within the scope of this invention. Thus, various changes and modifications may be made without departing from the spirit and scope of the invention. For instance, various components may be repositioned as desired. Moreover, not all of the features, aspects and advantages are necessarily required to practice the present invention. Accordingly, the scope of the present invention is intended to be defined only by the claims that follow.

What is claimed is:

1. A hydrogen supply pipe connecting structure for a system comprising a fuel cell adapted to generate electric power by reacting hydrogen gas, which is supplied from a hydrogen tank through a hydrogen supply pipe, with oxygen gas, which is supplied from an air supply device through an air supply pipe,
wherein the hydrogen supply pipe comprises a hydrogen tank side pipe portion and a fuel cell side pipe portion, a hydrogen tank side coupler connected to the hydrogen tank side pipe portion and a fuel cell side coupler connected to the fuel cell side pipe portion, the fuel cell side coupler being detachably connected to the hydrogen tank side coupler;
an electronic component being disposed on at least one of the hydrogen tank side pipe and the hydrogen tank, the electronic component being connected to the hydrogen tank side coupler through an electronic component side electric wire, the electronic component side electric wire being connected to a control device by a control device side electric wire, the control device side electric wire byeing connected to the fuel cell side coupler; and
the electronic component and the control device are electrically connected to or disconnected from each other in accordance with attachment/detachment of the hydrogen tank side coupler and the fuel cell side coupler.

2. The hydrogen supply pipe connecting structure according to claim 1,
wherein at least one of the hydrogen tank side coupler and the fuel cell side coupler is provided with a mechanism for closing a hydrogen supply path of the at least one of the pair of couplers, the mechanism comprising a resilient member that urges a valve element toward a valve seat; and
the other of the at least one of the hydrogen tank side coupler and the fuel cell side coupler is provided with a pressing section that is adapted to place a hydrogen supply path of the hydrogen tank side coupler in fluid communication with a hydrogen supply path of the fuel cell side coupler by moving the valve element away from the valve seat against an urging force of the resilient member; and
an electronic component side terminal that is coupled to an end of the electronic component side electric wire also is fixed to a given portion of the hydrogen tank side coupler, while a control device side terminal that is fixed to a given portion of the fuel cell side coupler also is electrically connected to the electronic component side terminal after the hydrogen tank side coupler and the fuel cell side coupler are connected in a generally airtight manner in a process of connecting the hydrogen tank side coupler and the fuel cell side coupler such that electronic component side terminal is coupled to the control device side terminal.

3. The hydrogen supply pipe connecting structure according to claim 2,
wherein the connection between the hydrogen tank side coupler and the fuel cell side coupler must be completed before the electronic component and the control device are electrically connected.

4. The hydrogen supply pipe connecting structure according to claim 2,
wherein the electronic component side terminal and the control device side terminal are moved away from each other before the hydrogen tank side coupler and the fuel cell side coupler are disconnected from each other during disconnection of the hydrogen tank side coupler and the fuel cell side coupler.

5. The hydrogen supply pipe connecting structure according to claim 4,
wherein the connection between the hydrogen tank side coupler and the fuel cell side coupler must be completed before the electronic component and the control device are electrically connected.

6. The hydrogen supply pipe connecting structure according to claim 2,
wherein the pressing section comprises a tube member that fluidly connects the hydrogen supply path of the hydrogen tank side coupler with the hydrogen supply path of the fuel cell side coupler in a generally airtight manner.

7. The hydrogen supply pipe connecting structure according to claim 6,
wherein the connection between the hydrogen tank side coupler and the fuel cell side coupler must be completed before the electronic component and the control device are electrically connected.

8. The hydrogen supply pipe connecting structure according to claim 6,
wherein the electronic component side terminal and the control device side terminal are moved away from each other before the hydrogen tank side coupler and the fuel cell side coupler are disconnected from each other during disconnection of the hydrogen tank side coupler and the fuel cell side coupler.

9. The hydrogen supply pipe connecting structure according to claim 8,
wherein the connection between the hydrogen tank side coupler and the fuel cell side coupler must be completed before the electronic component and the control device are electrically connected.

10. The hydrogen supply pipe connecting structure according to claim 2,
wherein the pressing section comprises a tubular communicating section that fluidly connects the hydrogen supply path of the hydrogen tank side coupler with the hydrogen supply path of the fuel cell side coupler in a generally airtight manner;
the pressing section further comprising a pressing rod that can be inserted into the tubular communicating section;
each of the hydrogen tank side coupler and the fuel cell side coupler being provided with the mechanism that closes the hydrogen supply path of each coupler, the mechanisms each comprising a resilient member that urges the valve element toward the valve seat;
one of the pair of couplers comprising the tubular communicating section and the other one of the pair of couplers comprising the pressing rod;
and the communicating section and the pressing rod moving the valve elements rearward against the associated resilient member such that the hydrogen supply path of the hydrogen tank side coupler is placed in fluid communication with the hydrogen supply path of the fuel cell side coupler in a generally airtight manner.

11. The hydrogen supply pipe connecting structure according to claim 10,
wherein the connection between the hydrogen tank side coupler and the fuel cell side coupler must be completed before the electronic component and the control device are electrically connected.

12. The hydrogen supply pipe connecting structure according to claim 10,
wherein the electronic component side terminal and the control device side terminal are moved away from each other before the hydrogen tank side coupler and the fuel cell side coupler are disconnected from each other during disconnection of the hydrogen tank side coupler and the fuel cell side coupler.

13. The hydrogen supply pipe connecting structure according to claim 12,
wherein the connection between the hydrogen tank side coupler and the fuel cell side coupler must be completed before the electronic component and the control device are electrically connected.

14. The hydrogen supply pipe connecting structure according to claim 2,
wherein a protruding piece covers a certain portion of at least one of the hydrogen tank side coupler and the fuel cell side coupler when the hydrogen tank side coupler and the fuel cell side coupler are connected in a generally airtight manner; and
one of the electronic component side terminal and the control device side terminal is fixed to an inner surface of the protruding piece while the other one of the electronic component side terminal and the control device side terminal is fixed to the covered portion of other one of the hydrogen tank side coupler and the fuel cell side coupler.

15. The hydrogen supply pipe connecting structure according to claim 14,
wherein the electronic component side terminal and the control device side terminal make frictional contact with each other while bringing the terminals into electrical connection when connecting the hydrogen tank side coupler and the fuel cell side coupler.

16. The hydrogen supply pipe connecting structure according to claim 2,
wherein an opposed section that faces a distal end portion of one of the hydrogen tank side coupler and the fuel cell side coupler when the hydrogen tank side coupler and the fuel cell side coupler are connected in a generally airtight manner is provided on the other one of the hydrogen tank side coupler and the fuel cell side coupler; and
one of the electronic component side terminal and the control device side terminal is fixed to the opposed section while the other one of the electronic component side terminal and the control device side terminal is fixed to the distal end portion.

17. The hydrogen supply pipe connecting structure according to claim 16,
wherein the electronic component side terminal and the control device side terminal make frictional contact with each other while bringing the terminals into electrical connection when connecting the hydrogen tank side coupler and the fuel cell side coupler.

18. The hydrogen supply pipe connecting structure according to claim 1,
wherein the electronic component is at least one of a solenoid valve that opens or closes the hydrogen tank side pipe, a hydrogen remaining amount detecting sensor that detects a remaining amount of hydrogen in the hydrogen tank, and a temperature sensor that detects the temperature of the hydrogen tank.

19. The hydrogen supply pipe connecting structure according to claim 1 in combination with a motorcycle.
